(19) United States
(12) Patent Application Publication
(10) Pub. No.: US 2014/0232505 A1
(43) Pub. Date: Aug. 21, 2014

(54) COIL STRUCTURE AND ELECTRONIC DEVICE

(71) Applicant: HONDA MOTOR CO., LTD., Tokyo (JP)

(72) Inventors: Satoshi Ueno, Utsunomiya-shi (JP); Kazuhiko Yamaguchi, Utsunomiya-shi (JP); Tsutomu Fukui, Haga-gun (JP)

(73) Assignee: HONDA MOTOR CO., LTD., Tokyo (JP)

(21) Appl. No.: 14/179,898

(22) Filed: Feb. 13, 2014

(30) Foreign Application Priority Data
Feb. 19, 2013 (JP) 2013-029812

(51) Int. Cl. H01F 17/06

(52) U.S. Cl. CPC H01F 17/062
USPC 336/212

(57) ABSTRACT

A coil structure according to one embodiment of the present invention includes, but is not limited to: a plurality of core members having impedances with different frequency characteristics; and a winding wire member wound around the plurality of core members.

### BACKGROUND OF THE INVENTION

1. Field of the Invention

The present invention relates to a coil structure and an electronic device.

Priority is claimed on Japanese Patent Application No. 2013-029812, filed Feb. 19, 2013, the content of which is incorporated herein by reference.

2. Description of the Related Art

There has been a signal transmission circuit that reduces common node noise of two signal lines using a bifilar-wound common mode choke coil obtained by winding two coils around a common core in the same direction (see, for example, Japanese Patent Unexamined Application, First Publication No. 2005-354140).

According to the signal transmission circuit of the related art, in order to increase a common mode impedance with respect to a wide frequency band (such as frequency bands for AM and FM radios), it is necessary to increase the number of turns in a coil of an electromagnetic interference wave measurement device or the like, which minutely measures an electromagnetic interference wave arising from an electric electronic component or the like.

In a case where the number of turns in a coil is increased, however, capacitive coupling between coils increases, thereby causing a reduction in the common mode impedance in a high frequency region. Additionally, in a case where it is necessary to reduce a normal mode impedance while increasing the common mode impedance, an increase in the number of turns in the coil causes an increase in the normal mode impedance due to the inductance of the coil itself.

The present invention has been made in view of the above situations and has an object to provide a coil structure and an electronic device, which can obtain adequate and desired impedance characteristics in a wide frequency band.

### SUMMARY

A coil structure according to one embodiment of the present invention includes, but is not limited to: a plurality of core members having impedances with different frequency characteristics; and a winding wire member wound around the plurality of core members.

An electronic device according to one embodiment may include, but is not limited to: a coil structure including a plurality of core members having impedances with different frequency characteristics, and a winding wire member wound around the plurality of core members; and an attenuation unit configured to attenuate a common node noise or a normal mode noise.

### BRIEF DESCRIPTION OF THE DRAWINGS

The above features and advantages of the present invention will be more apparent from the following description of certain preferred embodiments taken in conjunction with the accompanying drawings.

FIG. 1 is a planar view illustrating a coil structure according to an embodiment of the present invention, which is viewed in an axis direction of core members.

FIG. 2 is a view illustrating a structure of a winding wire member of the coil structure according to the embodiment.

FIG. 3A is a graph illustrating a frequency characteristic of a common mode impedance of the coil structure according to the embodiment.

FIG. 3B is a graph illustrating a frequency characteristic of a normal mode impedance of the coil structure according to the embodiment.

FIG. 4A is a planar view illustrating a coil structure according to a first modified example of the embodiment, which is viewed in an axis direction of core members.

FIG. 4B is a planar view illustrating the coil structure according to the first modified example of the embodiment, which is viewed in a direction perpendicular to the axis direction of the core members.

FIG. 5A is a graph illustrating a frequency characteristic of a common mode impedance of the coil structure according to the first modified example.

FIG. 5B is a graph illustrating a frequency characteristic of a normal mode impedance of the coil structure according to the first modified example.

FIG. 6 is a planar view illustrating a coil structure according to a second modified example of the embodiment, which is viewed in an axis direction of core members.

FIG. 7A is a graph illustrating a frequency characteristic of a common mode impedance of the coil structure according to the second modified example.

FIG. 7B is a graph illustrating a frequency characteristic of a normal mode impedance of the coil structure according to the second modified example.

FIG. 8 is a view illustrating a structure of a winding wire member of a coil structure according to a third modified example of the embodiment.

FIG. 9 is a view illustrating a structure of a winding wire member of a coil structure according to a fourth modified example of the embodiment, which is viewed in an axis direction of core members.

FIG. 10 is a planar view illustrating a winding wire member of a coil structure according to a fifth modified example of the embodiment, which is viewed in an axis direction of core members.

FIG. 11 is a view illustrating a structure of an electronic device according to the embodiment.

### DETAILED DESCRIPTION OF THE PREFERRED EMBODIMENTS

The present invention will now be described herein with reference to illustrative embodiments. The accompanying drawings explain coil structures and electronic devices in the embodiments. The size, the thickness, and the like of each illustrated portion might be different from those of each portion of actual devices.

Those skilled in the art will recognize that many alternative embodiments can be accomplished using the teachings of the present invention and that the present invention is not limited to the embodiments illustrated herein for explanatory purposes.

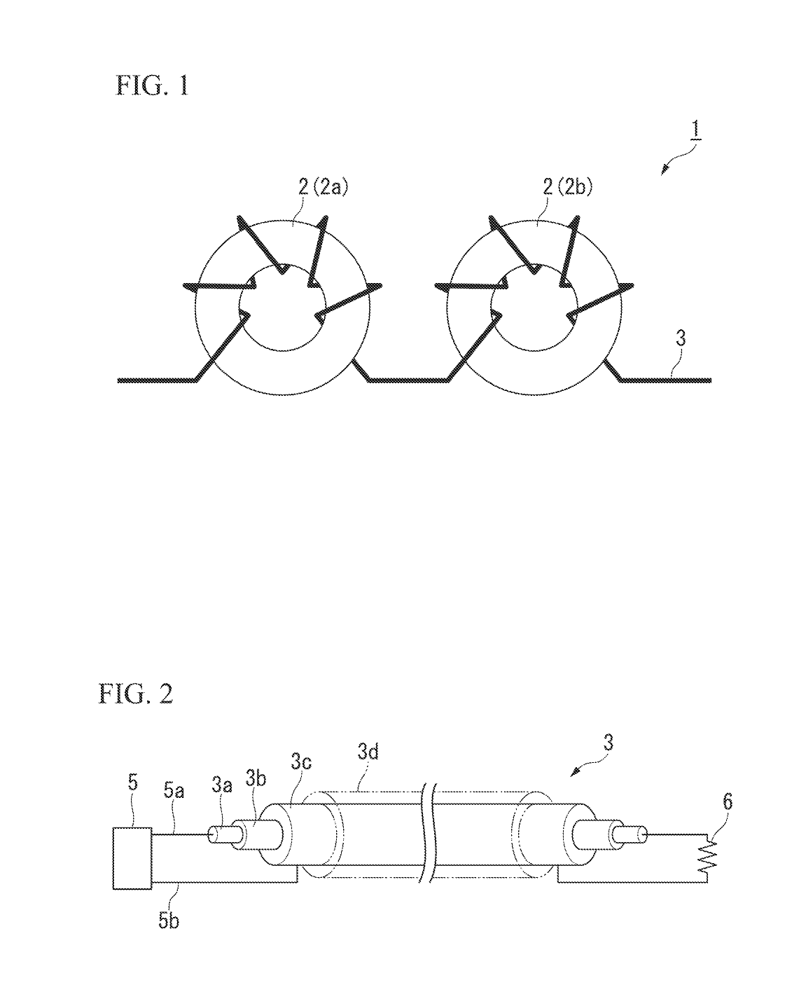

FIG. 1 is a planar view illustrating a coil structure 1 according to an embodiment of the present invention, which is viewed in an axis direction of core members. The coil structure 1 includes: multiple core members 2 with different frequency characteristics of impedances; and a winding wire member 3 wound around the core members 2.

For example, the core members 2 are independent of each other. The winding wire member 3 is wound sequentially around the core members 2.

The core members 2 include, for example, a first Mn—Zn core member 2a and a second Ni—Zn core member 2b. The first and second core members 2a and 2b have, for example, a circular ring shape. The winding wire member 3 is spirally wound around the core members 2 in the same circumferential direction.

FIG. 2 is a view illustrating a structure of the winding wire member 3 of the coil structure 1 according to the embodiment. The winding wire member 3 is a coaxial cable and includes: a core 3a made of a conductor; an insulating layer 3b covering the core 3a and made of a dielectric substance; a shielding braided wire 3c covering the insulating layer 3b and made of a conductor; and a protective surface film 3d covering the shielding braided wire 3c and made of an insulator.

The core 3a and the shielding braided wire 3c of the winding wire member 3 serve two single-phase signal lines. Thus, the core 3a and the shielding braided wire 3c constitute two signal lines bifilar-wound around the first and second core members 2a and 2b.

For example, the core 3a and the shielding braided wire 3c of the winding wire member 3 are coupled to two signal lines 5a and 5b and are terminally-coupled to a terminal resistor 6. The signal lines 5a and 5b are coupled to an appropriate electronic device 5. The terminal resistor 6 has a predetermined terminal resistance value (such as 50Ω) which is the same as a characteristic impedance of the winding wire member 3. Here, the appropriate electronic device 5 includes, for example, a measurement device used for measuring an impedance, such as a vector signal analyzer, a spectral analyzer, or an oscilloscope.

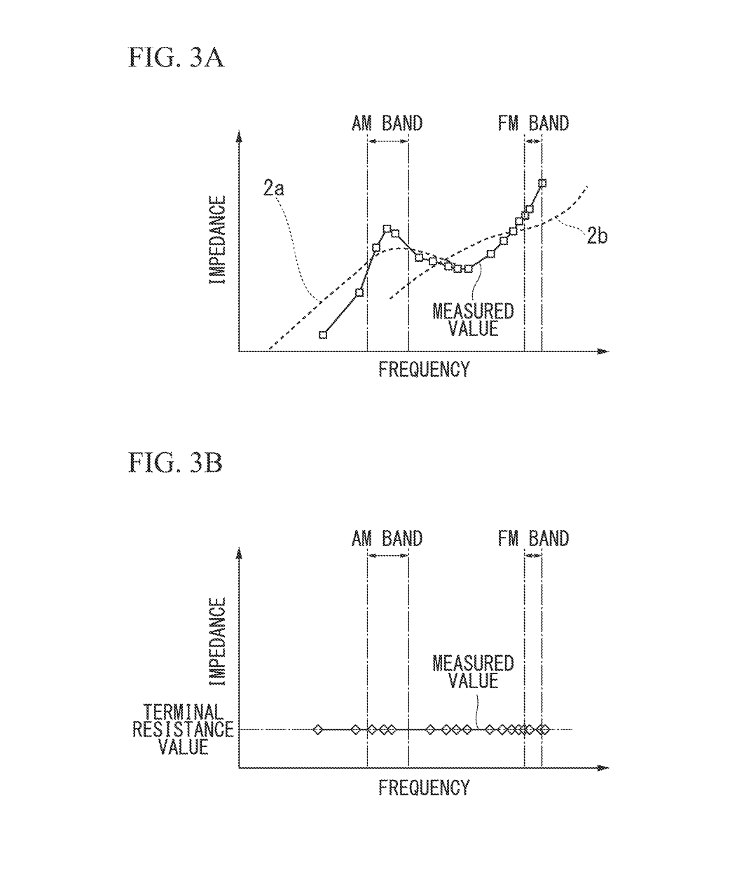

FIG. 3A is a graph illustrating a frequency characteristic of a common mode impedance of the coil structure 1 according to the embodiment. As indicated by an actual measured value shown in FIG. 3A, the frequency characteristic of the common mode impedance of the coil structure 1 is such an impedance characteristic as can be obtained by adding or combining the frequency characteristics of the common mode impedances of the first core member 2a for low frequency and the second core member 2b for high frequency.

FIG. 3B is a graph illustrating a frequency characteristic of a normal mode impedance of the coil structure 1 according to the embodiment. As indicated by an actual measured value shown in FIG. 3B, the frequency characteristic of the normal mode impedance of the coil structure 1 substantially matches a predetermined terminal resistance value (such as 50Ω) that is the same as the characteristic impedance of the winding wire member 3 in a wide band including, for example, the frequency bands for the AM and FM radios (AM and FM bands).

Thus, the coil structure 1 functions as a common mode choke coil or a normal mode choke coil. For example, in a case where the core 3a and the shielding braided wire 3c of the winding wire member 3, which constitute two signal lines, are normally coupled to external signal lines so that current flows in the two lines in the same direction, the current passes so as to attenuate common mode noise without attenuating normal mode noise. On the other hand, in a case where the core 3a and the shielding braided wire 3c of the winding wire member 3, which constitute two signal lines, are abnormally coupled to external signal lines so that current flows in the two lines in different directions (i.e., current flows in a differential mode), the current passes so as to attenuate normal mode noise without attenuating common mode noise.

As explained above, according to the coil structure 1 of the embodiment, it is possible to obtain such an impedance characteristic as can be obtained by adding or combining the frequency characteristics of the common mode impedances of the core members 2 (such as the first core member 2a for low frequency and the second core member 2b for high frequency). Thus, a desired common mode impedance can be appropriately obtained in a wide band including the AM and FM bands and the like without providing a coil structure dedicated for each of bands and increasing the normal mode impedance.

Further, impedance matching is performed on the coaxial cable constituting the winding wire member 3, thereby further reducing the normal mode impedance.

Moreover, the winding wire member 3 has a simple structure such as being wound sequentially around the core members 2, thereby preventing the structure of the coil structure 1 from being complicated.

### First Modified Example

In the above embodiment, the core members 2 may integrally constitute a single core 7a, and the winding wire member 3 may be wound around the signal core 7a.

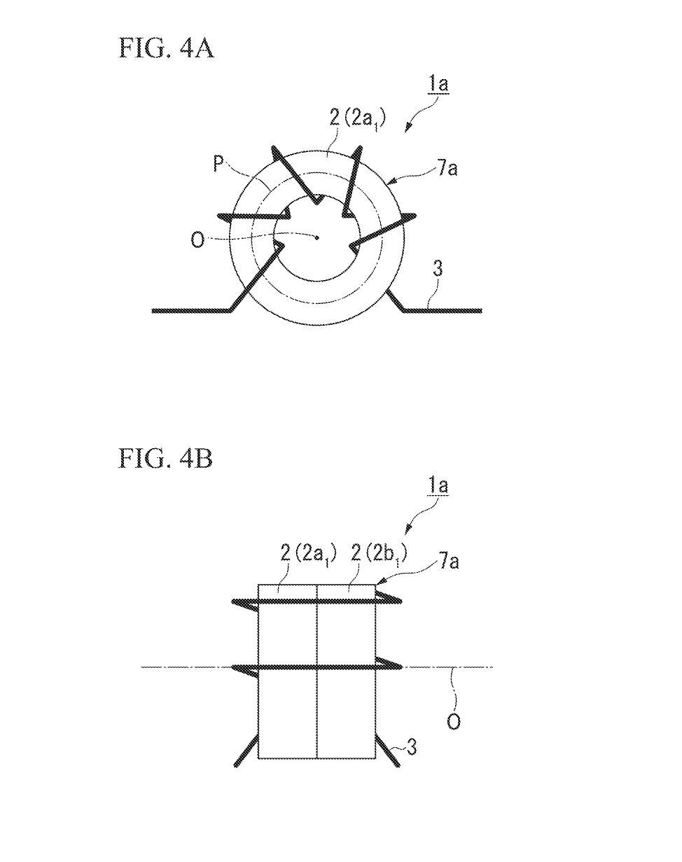

FIG. 4A is a planar view illustrating a coil structure 1a according to a first modified example of the embodiment, which is viewed in an axis direction of core members 2a₁ and 2b₁. FIG. 4B is a planar view illustrating the coil structure 1a according to the first modified example of the embodiment, which is viewed in a direction perpendicular to an axis direction of the core members 2a₁ and 2b₁.

The first core member 2a₁ and the second core member 2b₁ have a circular ring shape with the same inner and outer diameters. The first and second core members 2a₁ and 2b₁ are coaxially coupled to each other in a direction perpendicular to the axis direction of the center axis P of the winding wire member 3 (i.e., a direction of the center axes O of the first and second core members 2a₁ and 2b₁), thus forming the single core 7a.

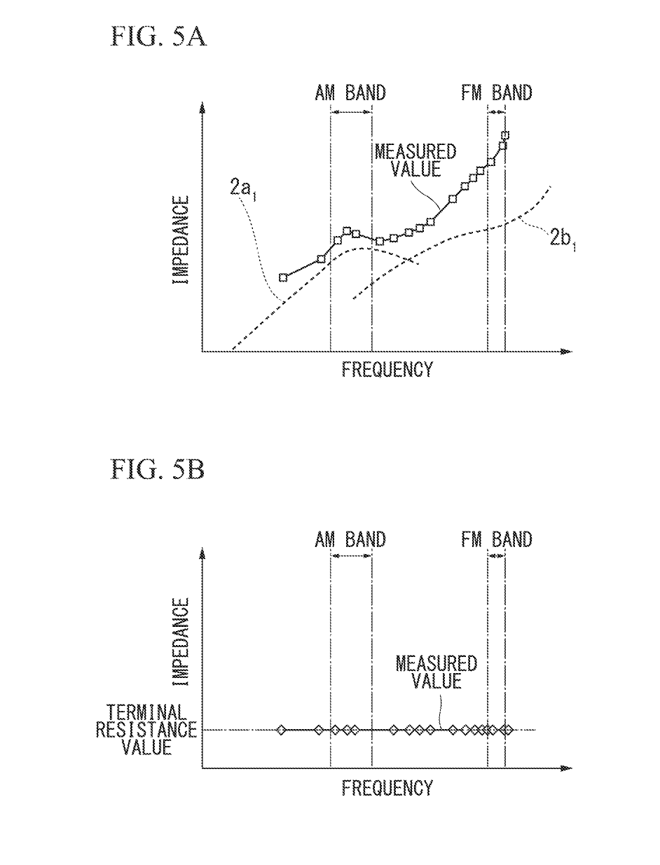

FIG. 5A is a graph illustrating a frequency characteristic of a common mode impedance of the coil structure 1a according to the first modified example. As indicated by an actual measured value shown in FIG. 5A, the frequency characteristic of the common mode impedance of the coil structure 1a is such an impedance characteristic as can be obtained by adding the frequency characteristics of the common mode impedances of the first core member 2a₁ for low frequency and the second core member 2b₁ for high frequency.

FIG. 5B is a graph illustrating a frequency characteristic of a normal mode impedance of the coil structure 1a according to the first modified example. As indicated by an actual measured value shown in FIG. 5B, the frequency characteristic of the normal mode impedance of the coil structure 1a substantially matches a predetermined terminal resistance value (such as 50Ω) that is the same as the characteristic impedance of the winding wire member 3 in a wide band including, for example, the frequency bands for the AM and FM radios (the AM and FM bands).

According to the first modified example, the coil structure 1a can be miniaturized. Further, the wiring member 3 can be wound around the core members 2a₁ and 2b₁ simply by being wound around the single core 7a, thereby simplifying a process of winding the wiring member 3.

### Second Modified Example

In the above embodiment, the core members 2 may integrally constitute a single core 7b, and the winding wire member 3 may be wound around the signal core 7b.

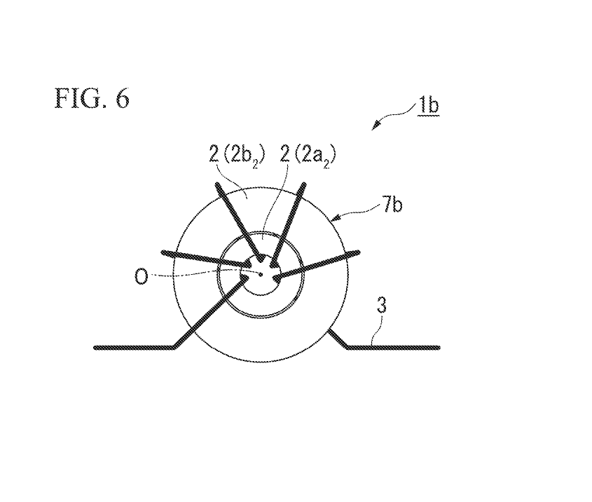

FIG. 6 is a planar view illustrating a coil structure 1b according to a second modified example of the embodiment, which is viewed in an axis direction of core members 2a₂ and 2b₂.

The first core member 2a₂ and the second core member 2b₂ have circular ring shapes with different inner and outer diameters from each other. The outer diameter of the first core member 2a₂ is a little smaller than the inner diameter of the second core member 2b₂. The first core member 2a₂ and the second core member 2b₂ are coaxially coupled to each other in a direction perpendicular to the axis direction of the center axes O of the first and second core members 2a₂ and 2b₂ (i.e., a diameter direction), thus forming the single core 7b.

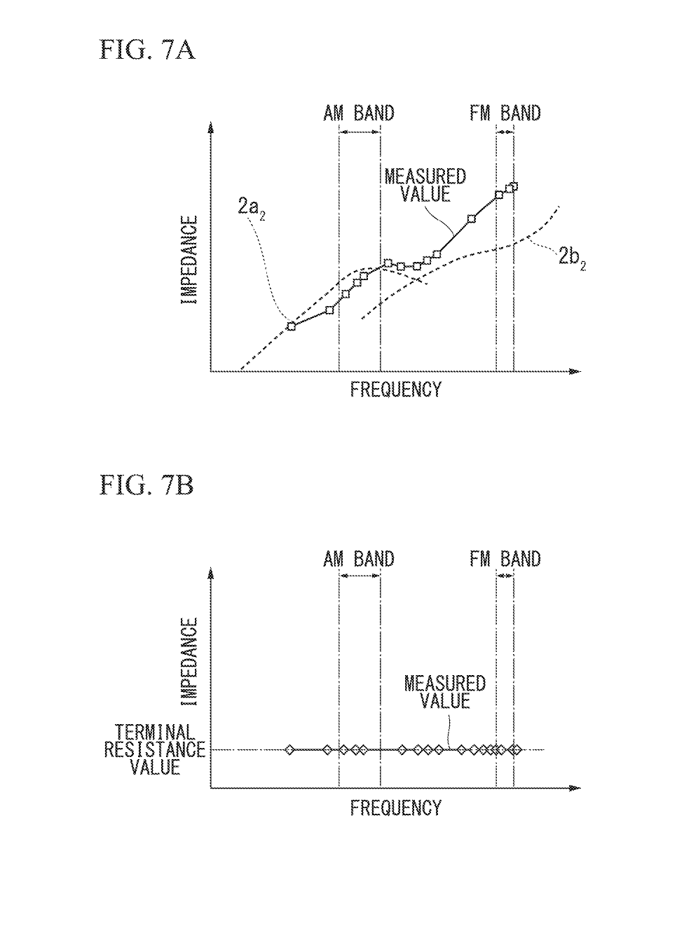

FIG. 7A is a graph illustrating a frequency characteristic of a common mode impedance of the coil structure 1b according to the second modified example. As indicated by an actual measured value shown in FIG. 7A, the frequency characteristic of the common mode impedance of the coil structure 1b is such an impedance characteristic as can be obtained by adding the frequency characteristics of the common mode impedances of the first core member 2a₂ for low frequency and the second core member 2b₂ for high frequency.

FIG. 7B is a graph illustrating a frequency characteristic of a normal mode impedance of the coil structure 1b according to the second modified example. As indicated by an actual measured value shown in FIG. 7B, the frequency characteristic of the normal mode impedance of the coil structure 1b substantially matches a predetermined terminal resistance value (such as 50Ω) that is the same as the characteristic impedance of the winding wire member 3 in a wide band including, for example, the frequency bands for the AM and FM radios (the AM and FM bands).

According to the second modified example, the coil structure 1b can be miniaturized. Further, the winding wire member 3 can be wound around the core members 2a₂ and 2b₂ simply by being wound around the single core 7b, thereby simplifying a process of winding the wiring member 3.

In the second modified example, the first core member 2a₂ for low frequency is placed on the inner circumferential side of the second core member 2b₂ for high frequency. However, the configuration of the second modified example is not limited thereto. For example, the second core member 2b₂ for high frequency may be placed on the inner circumferential side of the first core member 2a₂ for low frequency.

### Third Modified Example

It has been explained in the above embodiment and the first and second modified examples that the core 3a and the shielding braided wire 3c of the winding wire member 3 are two single-phase signal lines. However, the winding wire member 3 may include three or more multi-phase signal lines.

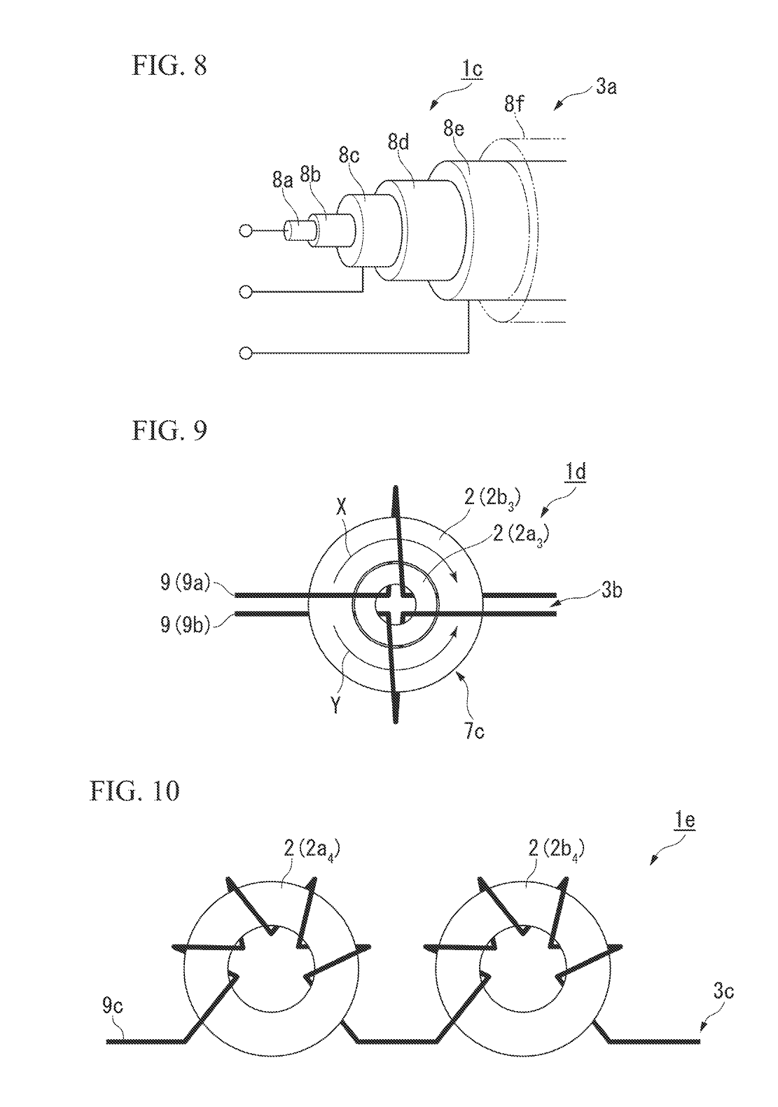

FIG. 8 is a view illustrating a structure of a winding wire member 3a of a coil structure 1c according to a third modified example of the embodiment. The winding wire member 3a of the coil structure 1c shown in FIG. 8 is a coaxial cable and includes: a core 8a made of a conductor; a first insulating layer 8b covering the core 8a and made of a dielectric substance; a first shielding braided wire 8c covering the first insulating layer 8b and made of a conductor; a second insulating layer 8d covering the first shielding braided wire 8c and made of a dielectric substance; a second shielding braided wire 8e covering the second insulating layer 8d and made of a conductor; and a protective surface film 8f covering the second shielding braided wire 8e and made of an insulator. Regarding the winding wire member 3a, the core 8a and the first and second shielding braided wires 8c and 8e serve three three-phase signal lines. Thus, the core 8a and the first and second shielding braided wires 8c and 8e constitute three signal lines bifilar-wound around the first and second core members 2a and 2b.

According to the third modified example, the coil structure 1c is applicable to a multi-phase circuit, such as a three-phase motor.

### Fourth Modified Example

In the above embodiment and the first and second modified examples, the winding wire member 3 is not limited to the coaxial cable, and may include multiple conductive wires 9 made of multiple independent conductors. Further, one pair of conductive wires 9 may be wound around the core members 2 by cancelling winding, not limited to bifilar winding. Moreover, in a case where one pair of conductive wires 9 is wound by cancelling winding, one pair of conductive wires 9 may be wound so as to generate the same-phase voltage or the reverse-phase voltage.

FIG. 9 is a view illustrating a structure of a winding wire member 3b of a coil structure 1d according to a fourth modified example of the embodiment, which is viewed in an axis direction of core members 2a₃ and 2b₃.

The first core member 2a₃ and the second core member 2b₃ have circular ring shapes with different inner and outer diameters from each other. The outer diameter of the first core member 2a₃ is a little smaller than the inner diameter of the second core member 2b₃. The first core member 2a₃ and the second core member 2b₃ are coaxially coupled to each other in a direction perpendicular to an axis direction of the center axes O of the first and second core members 2a₃ and 2b₃ (i.e., a diameter direction), thus forming a single core 7c.

The winding wire member 3b includes first and second conductive wires 9a and 9b. The first and second conductive wires 9a and 9b are spirally wound around the first and second core members 2a₃ and 2b₃ in the first and second circumferential directions X and Y (i.e., different circumferential directions toward the same horizontal direction) so as to generate the reverse-phase voltage.

The coil structure 1d shown in FIG. 9 functions as a normal mode choke coil. In a case where the coil structure 1d is coupled to external signal lines, current passes so as to attenuate normal mode noise without attenuating common mode noise.

### Fifth Embodiment

In the above embodiment and the first and second modified examples, the winding wire member 3 may include a single conductive wire 9 made of a single conductor, not limited to multiple conductors.

FIG. 10 is a planar view illustrating a winding wire member 3c of a coil structure 1e according to a fifth modified example of the embodiment, which is viewed in an axis direction of core members 2a₄ and 2b₄.

The single conductive wire 9 is spirally wound around the first and second core members 2a₄ and 2b₄ in the same circumferential direction. The coil structure 1e functions as an inductor.

According to the fifth modified example, it is possible to achieve a wider bandwidth of the impedance characteristic of the single coil.

The coil structure 1 according to the present embodiment is included in an electronic device, such as an electromagnetic interference wave measurement device 20 that measures a conductive interference wave (conductive emission) that transfers via a coupling cable. The conductive interference wave is included in electromagnetic interference (EMI) waves arising from an electric electronic component 10 mounted on a vehicle or the like.

For example, first and third common mode choke coils 33 and 35, which will be explained later, have any one of the coil structures 1, 1a, and 1b of the above embodiment and the first and second modified examples.

For example, a second common mode choke coil 34, which will be explained later, has the coil structure 1d of the above fourth modified example.

For example, winding wires 43 and 53, which will be explained later, have the coil structure 1e of the above fifth modified example.

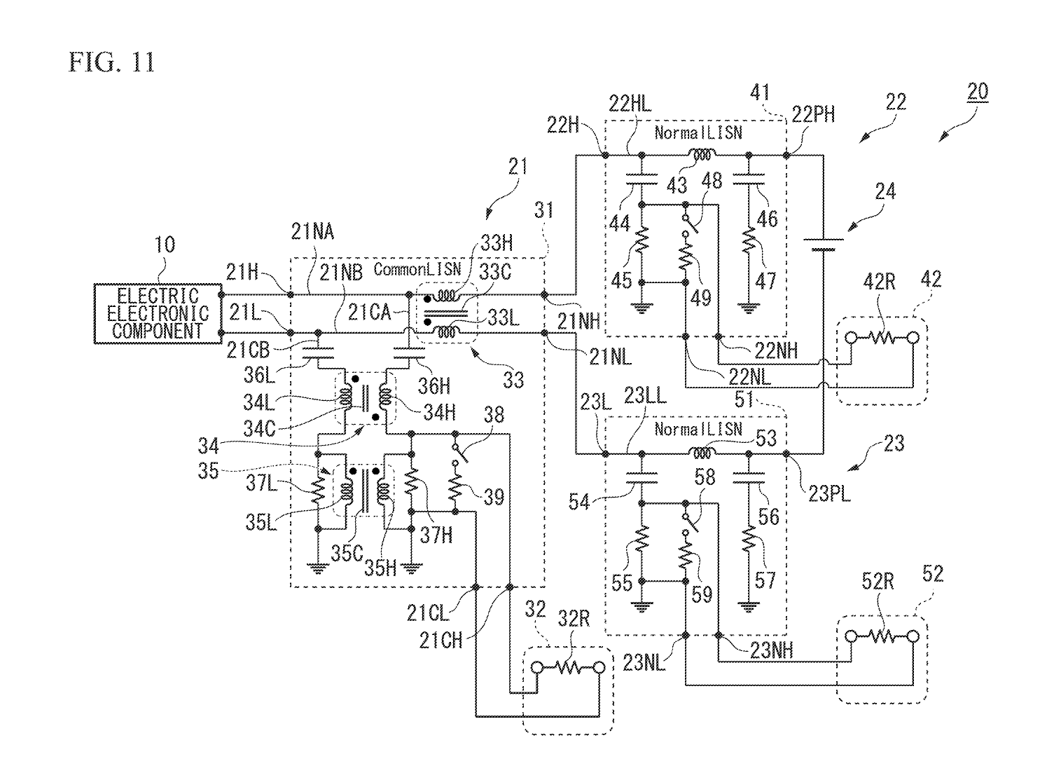

FIG. 11 is a view illustrating a structure of the electromagnetic interference wave measurement device 20 according to the present embodiment. The electromagnetic interference wave measurement device 20 includes: a common mode noise detector 21; a first normal mode noise detector 22; a second normal mode noise detector 23; and a power source 24.

The common mode noise detector 21 includes, for example, a noise divider 31 and an electronic measurer 32.

The noise divider (CommonLISN) 31 includes, for example, a line impedance stabilization network (LISN). The noise divider 31 divides into a common mode noise and a normal mode noise, noises occurring to Hi-side and Lo-side input terminals 21H and 21L coupled to the electric electronic component 10. Then, the noise divider 31 outputs the divided common mode noises to Hi-side and Lo-side common mode output terminals 21CH and 21CL. Additionally, the noise divider 31 outputs the divided normal mode noise to Hi-side and Lo-side normal mode output terminals 21NH and 21NL.

The noise divider 31 includes, for example: first to third common mode choke coils 33, 34, and 35; a pair of capacitors 36H and 36L; a pair of resistors 37H and 37L; a terminal resistor change switch 38; and a change terminal resistor 39.

The first common mode choke coil 33 includes, for example, a pair of winding wires 33H and 33L, and a core 33C. The pair of winding wires 33H and 33L are electromagnetically-coupled to each other via the core 33C. The pair of winding wires 33H and 33L are wound such that an inductance with respect to the normal mode noise is nullified, and an inductance with respect to the common mode noise is greater than the inductance with respect to the normal mode noise.

The winding wire 33H is inserted on a normal mode coupling wire 21NA that couples the Hi-side input terminal 21H and the Hi-side normal mode output terminal 21NH. The winding wire 33L is inserted on a normal mode coupling wire 21NB that couples the Lo-side input terminal 21L and the Lo-side normal mode output terminal 21NL.

The first common mode choke coil 33 generates a mutual inductance between the normal mode coupling wires 21NA and 21NB, thereby attenuating a common mode noise without attenuating the normal mode noise.

The winding wires 33H and 33L include, for example, coaxial cables. The winding wires 33H and 33L suppress attenuation of the normal mode noise while maintaining the attenuation level of the common mode noise. Further, the winding wires 33H and 33L can further suppress attenuation of the normal mode noise by impedance matching being performed between end terminals of the coaxial cables.

The second common mode choke coil 34 includes, for example, a pair of winding wires 34H and 34L, and a core 34C. The pair of winding wires 34H and 34L are electromagnetically-coupled to each other via the core 34C. The pair of winding wires 34H and 34L are wound such that an inductance with respect to the common mode noise is nullified, and an inductance with respect to the normal mode noise is greater than the inductance with respect to the common mode noise.

The third common mode choke coil 35 includes, for example, a pair of winding wires 35H and 35L, and a core 35C. The pair of winding wires 35H and 35L are electromagnetically-coupled to each other via the core 35C. The pair of winding wires 35H and 35L are wound such that the inductance with respect to the normal mode noise is nullified, and the inductance with respect to the common mode noise is greater than the inductance with respect to the normal mode noise.

The winding wires 35H and 35L include, for example, coaxial cables. The winding wires 35H and 35L suppress attenuation of the normal mode noise while maintaining the attenuation level of the common mode noise. Further, the winding wires 35H and 35L can further suppress attenuation of the normal mode noise by impedance matching being performed between end terminals of the coaxial cables.

For example, the capacitor 36H and the winding wires 34H and 35H are sequentially coupled in series, and are inserted on a common mode coupling wire 21CA that couples the Hi-side input terminal 21H and a ground point. For example, the capacitor 36L and the winding wires 34L and 35L are sequentially coupled in series, and are inserted on a common mode coupling wire 21CB that couples the Lo-side input terminal 21L and a ground point.

The pair of winding wires 34H and 34L included in the second common mode choke coil 34 are wound so as to mutually generate the inverse voltages, and are inserted respectively on the common mode coupling wires 21CA and 21CB.

The second common mode choke coil 34 generates a mutual inductance between the common mode coupling wires 21CA and 21CB, thereby attenuating the normal mode noise without attenuating the common mode noise.

Both ends of the winding wire 35H included in the third common mode choke coil 35 are coupled to the Hi-side and Lo-side common mode output terminals 21CH and 21CL.

For example, the resistor 37H is coupled between both ends of the winding wire 35H included in the third common mode choke coil 35. For example, the resistor 37L is coupled between both ends of the winding wire 35L included in the third common mode choke coil 35.

For example, the third common mode choke coil 35 generates a mutual inductance between the common mode coupling wires 21CA and 21CB, thereby causing the normal mode noise to pass to the ground point (i.e., short-circuit with the ground).

The third common mode choke coil 35 and the pair of resistors 37H and 37L, by the transforming function or the like, induce between the Hi-side and Lo-side common mode output terminals 21CH and 21CL, the voltage between both ends of the resistor 37L arising from the common mode noise.

For example, the terminal resistor change switch 38 and the change terminal resistor 39 are coupled in series between the Hi-side and Lo-side common mode output terminals 21CH and 21CL.

The electronic measurer 32 includes a measurer that quantifies the amount (the level or the like) of noise including a temporal variation thereof, such as a vector analyzer, a spectrum analyzer, or an oscilloscope. The electronic measurer 32 measures the voltage of noise output from the Hi-side and Lo-side common mode output terminals 21CH and 21CL (for example, common mode noise).

The electronic measurer 32 includes, for example, a terminal resistor 32R that couples the Hi-side and Lo-side common mode output terminals 21CH and 21CL.

In a state where the terminal resistor change switch 38 is in the off-state, the electronic measurer 32 measures the common mode noise based on a first terminal resistance value (such as 50Ω) that depends on a resistance value (such as 50Ω) of the terminal resistor 32R. On the other hand, in a state where the terminal resistor change switch 38 is in the off-state, the electronic measurer 32 measures the common mode noise based on a second terminal resistance value (such as 25Ω) that depends on a combined value of the resistance value of the change terminal resistor 39 (such as 50Ω that is the same as the resistance value of the terminal resistance 32R) and the resistance value of the terminal resistance 32R (such as 50Ω).

The electronic measurer 32 estimates an internal impedance of the common mode noise of a single electric electronic component 10 based on a change in a result of the measurement that depends on a change in the terminal resistance value which occurs along with the switching between the on-state and the off-state of the terminal resistance change switch 38.

Then, the electronic measurer 32 estimates the output voltage of the common mode noise of the single electric electronic component 10 based on a result of the estimation of the internal impedance.

For example, V(50Ω) and V(25Ω), which are the results of the measurement of the voltage of the common mode noise based on the first terminal resistance value (such as 50Ω) and the second terminal resistance value (such as 25Ω) with respect to the common mode noise of the appropriate output voltage V(x) with the appropriate internal impedance Im(x) of the single electric electronic component 10, vary as shown in Formula (1).

In other words, when the terminal resistance value switches between the first terminal resistance value (such as 50Ω) and the second terminal resistance value (such as 25Ω) by the states of the terminal resistance change switch 38 being switched between the on-state and the off-state, a divided voltage ratio of the internal impedance Im(x) and the terminal resistance value varies. Then, in accordance with the change in the divided voltage ratio, V(50Ω) and V(25Ω), which are the results of the measurement of the voltage of the common mode noise, vary as shown in Formula (1).

$$\begin{matrix}[ Formula 1 ] & \\ \begin{matrix}V ( 50 Ω ) = \frac{50}{50 + Im ( x )} \times V ( x ) \\ V ( 25 Ω ) = \frac{25}{25 + Im ( x )} \times V ( x )\end{matrix} \} & ( 1 )\end{matrix}$$

Based on the amount of a variation ΔV caused by the change in the result of the measurement of the common mode noise from V(25Ω) to V(50Ω), the electronic measurer 32 estimates an internal impedance Im(25Ω→50Ω) of the single electric electronic component 10, as shown in the following Formula (2).

$$\begin{matrix}[ Formula 2 ] & \\ Im ( 25 Ω \to 50 Ω ) = 50 \times \frac{( 1 - {10}^{( \frac{Δ V}{20} )} )}{( 2 \times {10}^{( \frac{Δ V}{20} )} - 1 )} & ( 2 )\end{matrix}$$

Here, the optimal values of the first and second terminal resistance values, which vary in accordance with the switching of the states of the terminal resistance change switch 38 between the on-state and the off-state, may be changed depending on the internal impedance Im(x).

In order to avoid reflection of an electromagnetic interference wave between the electromagnetic interference wave measurement device 20 and the electric electronic component 10, the distance of the Harness connection or the like between the electromagnetic interference wave measurement device 20 and the electric electronic component 10 may be set to be equal to or less than a predetermined value (such as λ/10 or λ/20 where λ denotes a wavelength of the electromagnetic interference wave).

The electronic measurer 32 estimates the output voltage P(50Ω) of the common mode noise based on the internal impedance Im(25Ω→50Ω) of the common mode noise and the result (such as V(50Ω)) of the measurement of the voltage of the common mode noise based on the first terminal resistance value (such as 50Ω), as shown in the following Formula (3).

$$\begin{matrix}[ Formula 3 ] & \\ P ( 50 Ω ) = 20 \times {log}_{10} ( \frac{Im ( 25 Ω \to 50 Ω ) + 50}{50} ) + V ( 50 Ω ) & ( 3 )\end{matrix}$$

The first normal mode noise detector 22 includes, for example, a pseudo power circuit network 41 and an electronic measurer 42.

The pseudo power circuit network (NormalLISN) 41 includes a line impedance stabilization network (LISN) or the like. The pseudo power circuit network 41 includes: a Hi-side normal mode input terminal 22H coupled to the Hi-side normal mode output terminal 21NH of the common mode noise detector 21; a Hi-side power terminal 22PH coupled to a positive electrode of the power source 24; and first Hi-side and Lo-side normal mode output terminals 22NH and 22NL.

The pseudo power circuit network 41 includes, for example: a winding wire 43; a first capacitor 44; a first resistor 45; a second capacitor 46; a second resistor 47; a terminal resistor change switch 48; and a change terminal resistor 49.

The winding wire 43 is inserted on a coupling wire 22HL that couples the Hi-side normal mode input terminal 22H and the Hi-side power terminal 22PH.

For example, the Hi-side normal mode input terminal 22H is coupled to a ground point via the first capacitor 44 and the first resistor 45 which are sequentially coupled in series.

For example, the Hi-side power terminal 22PH is coupled to a ground point via the second capacitor 46 and the second resistor 47 which are sequentially coupled in series.

Both ends of the first resistor 45 are coupled to first Hi-side and Lo-side normal mode output terminals 22NH and 22NL.

For example, the terminal resistor change switch 48 and the change terminal resistor 49 are coupled in series between the first Hi-side and Lo-side normal mode output terminals 22NH and 22NL.

The electronic measurer 42 includes a measurer that quantifies the amount (the level or the like) of noise including a temporal variation thereof, such as a vector analyzer, a spectrum analyzer, or an oscilloscope. The electronic measurer 42 measures the voltage of noise output from the first Hi-side and Lo-side normal mode output terminals 22NH and 22NL (such as Hi-side normal mode noise), or the like.

The electronic measurer 42 includes, for example, a terminal resistor 42R that couples the first Hi-side and Lo-side normal mode output terminals 22NH and 22NL.

In a state where the terminal resistor change switch 48 is in the off-state, the electronic measurer 42 measures Hi-side normal mode noise based on a first terminal resistance value (such as 50Ω) that depends on a resistance value (such as 50Ω) of the terminal resistor 42R. On the other hand, in a state where the terminal resistor change switch 48 is in the on-state, the electronic measurer 42 measures the Hi-side normal mode noise based on a second terminal resistance value (such as 25Ω) that depends on a combined value of the resistance value of the change terminal resistor 49 (such as 50Ω that is the same as the resistance value of the terminal resistance 42R) and the resistance value of the terminal resistance 42R (such as 50Ω).

Similar to the measurement of the common mode nose performed by the electronic measurer 32, the electronic measurer 42 estimates an internal impedance of the Hi-side normal mode noise of the single electric electronic component 10 based on a change in a result of the measurement that depends on a change in the terminal resistance value which is caused by the states of the terminal resistance change switch 48 being switched between the on-state and the off-state.

Then, the electronic measurer 42 estimates the output voltage of the Hi-side normal mode noise of the single electric electronic component 10 based on a result of the estimation of the internal impedance.

For example, as shown in Formula (1), the electronic measurer 42 obtains V(50Ω) and V(25Ω), which are the results of the measurement of the voltage of the Hi-side normal mode noise based on the first terminal resistance value (such as 50Ω) and the second terminal resistance value (such as 25Ω) with respect to the Hi-side normal mode noise of the appropriate output voltage V(x) with the appropriate internal impedance Im(x) of the single electric electronic component 10.

Based on the amount of a variation ΔV caused by the change in the result of the measurement of the Hi-side normal mode noise from V(25Ω) to V(50Ω), the electronic measurer 42 estimates an internal impedance Im(25Ω→50Ω) of the single electric electronic component 10, as shown in the above Formula (2).

Then, the electronic measurer 42 estimates the output voltage P(50Ω) of the Hi-side normal mode noise based on the internal impedance Im(25Ω→50Ω) of the Hi-side normal mode noise and the result (such as V(50Ω)) of the measurement of the voltage of the Hi-side normal mode noise based on the first terminal resistance value (such as 50Ω), as shown in the above Formula (3).

The second normal mode noise detector 23 includes, for example, a pseudo power circuit network 51 and an electronic measurer 52.

The pseudo power circuit network (NormalLISN) 51 includes a line impedance stabilization network (LISN) or the like. The pseudo power circuit network 51 includes: a Lo-side normal mode input terminal 22L coupled to the Lo-side normal mode output terminal 21NL of the common mode noise detector 21; a Lo-side power terminal 23PL coupled to a negative electrode of the power source 24; and second Hi-side and Lo-side normal mode output terminals 23NH and 23NL.

The pseudo power circuit network 51 includes, for example: a winding wire 53; a first capacitor 54; a first resistor 55; a second capacitor 56; a second resistor 57; a terminal resistor change switch 58; and a change terminal resistor 59.

The winding wire 53 is inserted on a coupling wire 23LL that couples a Lo-side normal mode input terminal 23L and a Lo-side power terminal 22PL.

For example, the Lo-side normal mode input terminal 23L is coupled to a ground point via the first capacitor 54 and the first resistor 55 which are sequentially coupled in series.

For example, the Lo-side power terminal 22PL is coupled to a ground point via the second capacitor 56 and the second resistor 57 which are sequentially coupled in series.

Both ends of the first resistor 55 are coupled to second Hi-side and Lo-side normal mode output terminals 22NH and 22NL.

For example, the terminal resistor change switch 58 and the change terminal resistor 59 are coupled in series between the second Hi-side and Lo-side normal mode output terminals 23NH and 23NL.

The electronic measurer 52 includes a measurer that quantifies the amount (the level or the like) of noise including a temporal variation thereof, such as a vector analyzer, a spectrum analyzer, or an oscilloscope. The electronic measurer 52 measures the voltage of noise output from the second Hi-side and Lo-side normal mode output terminals 23NH and 23NL (for example, Lo-side normal mode noises), or the like.

The electronic measurer 52 includes, for example, a terminal resistor 52R that couples the second Hi-side and Lo-side normal mode output terminals 23NH and 23NL.

In a state where the terminal resistor change switch 52 is in the on-state, the electronic measurer 52 measures Lo-side normal mode noise based on a first terminal resistance value (such as 50Ω) that depends on a resistance value (such as 50Ω) of the terminal resistor 52R. On the other hand, in a state where the terminal resistor change switch 58 is in the on-state, the electronic measurer 52 measures Lo-side normal mode noise based on a second terminal resistance value (such as 25Ω) that depends on a combined value of the resistance value of the change terminal resistor 59 (such as 50Ω that is the same as the resistance value of the terminal resistance 52R) and the resistance value of the terminal resistance 52R (such as 50Ω).

Similar to the measurement of the Hi-side normal mode nose performed by the electronic measurer 42, the electronic measurer 52 estimates an internal impedance of the Lo-side normal mode noise of the single electric electronic component 10 based on a change in a result of the measurement that depends on a change in the terminal resistance value which is caused by the states of the terminal resistance change switch 58 being switched between the on-state and the off-state.

Then, the electronic measurer 52 estimates the output voltage of the Lo-side normal mode noise of the single electric electronic component 10 based on a result of the estimation of the internal impedance.

For example, as shown in Formula (1), the electronic measurer 52 obtains V(50Ω) and V(25Ω), which are the results of the measurement of the voltage of the Lo-side normal mode noise based on the first terminal resistance value (such as 50Ω) and the second terminal resistance value (such as 25Ω) with respect to the Lo-side normal mode noise of the appropriate output voltage V(x) with the appropriate internal impedance Im(x) of the single electric electronic component 10.

Based on the amount of a variation ΔV caused by the change in the result of the measurement of the Lo-side normal mode noise from V(25Ω) to V(50Ω), the electronic measurer 52 estimates an internal impedance Im(25Ω→50Ω) of the single electric electronic component 10, as shown in the above Formula (2).

Then, the electronic measurer 52 estimates the output voltage P(50Ω) of the Lo-side normal mode noise based on the internal impedance Im(25Ω→50Ω) of the lo-side normal mode noise and the result (such as V(50Ω)) of the measurement of the voltage of the Lo-side normal mode noise based on the first terminal resistance value (such as 50Ω), as shown in the above Formula (3).

As explained above, according to the present embodiment, the electromagnetic interference wave measurement device 20 includes the coil structure 1. Thereby, it is possible to appropriately divide noises of conductive interference waves arising from the single electric electronic component 10 into common mode noise and normal mode noise, and thus measure those divided noises. Accordingly, it is possible to precisely estimate the internal impedances of the common mode noise and the normal mode noise and the noise levels of the noise sources (such as the output voltage).

In the above embodiment, the coil structure 1 may be included in an electronic device other than the electromagnetic interference wave measurement device 20.

As used herein, the following directional terms “forward,” “rearward,” “above,” “downward,” “vertical,” “horizontal,” “below,” and “transverse,” as well as any other similar directional terms refer to those directions of a device equipped with the present invention. Accordingly, these terms, as utilized to describe the present invention should be interpreted relative to a device equipped with the present invention.

The term “configured” is used to describe a component, section or part of a device which includes hardware and/or software that is constructed and/or programmed to carry out the desired function.

The terms of degree such as “substantially,” “about,” and “approximately” as used herein mean a reasonable amount of deviation of the modified term such that the end result is not significantly changed. For example, these terms can be construed as including a deviation of at least ±5 percent of the modified term if this deviation would not negate the meaning of the word it modifies.

It is apparent that the present invention is not limited to the above embodiments, and may be modified and changed without departing from the scope and spirit of the invention.

What is claimed is:

1. A coil structure comprising:
a plurality of core members having impedances with different frequency characteristics; and
a winding wire member wound around the plurality of core members.

2. The coil structure according to claim 1, wherein the plurality of core members are independent of one another, and
the winding wire member is wound sequentially around the plurality of core members.

3. The coil structure according to claim 1, wherein the plurality of core members integrally constitute a single core, and
the winding wire member is wound around the signal core.

4. The coil structure according to claim 3, wherein the single core has a ring shape, and
the plurality of core members are coupled in an axis direction of the single core.

5. The coil structure according to claim 3, wherein the single core has a ring shape, and
the plurality of core members are coupled in a direction perpendicular to an axis direction of the single core.

6. The coil structure according to claim 1, wherein the winding wire member includes a plurality of conductors, and
the plurality of conductors are wound around the plurality of core members by bifilar winding or cancelling winding.

7. The coil structure according to claim 6, wherein the plurality of conductors are coaxially layered via a plurality of insulators to constitute a coaxial cable, and
the plurality of conductors are bifilar-wound around the plurality of core members.

8. The coil structure according to claim 7, wherein the coaxial cable is subjected to impedance matching.

9. An electronic device comprising:
a coil structure comprising:
a plurality of core members having impedances with different frequency characteristics; and
a winding wire member wound around the plurality of core members; and
an attenuation unit configured to attenuate a common node noise or a normal mode noise.
